(19) United States
(12) Patent Application Publication
(10) Pub. No.: US 2025/0391343 A1
(43) Pub. Date: Dec. 25, 2025

(54) PIXEL CIRCUIT, DISPLAY DEVICE INCLUDING THE PIXEL CIRCUIT AND ELECTRONIC DEVICE INCLUDING THE PIXEL CIRCUIT

(71) Applicant: Samsung Display Co., LTD., Yongin-si (KR)

(72) Inventor: SANGJIN JEON, Yongin-si (KR)

(21) Appl. No.: 19/226,429

(22) Filed: Jun. 3, 2025

(30) Foreign Application Priority Data
Jun. 25, 2024 (KR) 10-2024-0083021
Nov. 1, 2024 (KR) 10-2024-0153140

(51) Int. Cl. G09G 3/32

(52) U.S. Cl. CPC G09G 3/32; G09G 2300/0819; G09G 2300/0852; G09G 2300/0861; G09G 2310/08; G09G 2320/0238

(57) ABSTRACT

A pixel circuit includes a first circuit block and a second circuit block. The first circuit block includes a first transistor including a control electrode connected to a first node, a first electrode connected to a second node and a second electrode connected to a third node, a second transistor which applies the pulse data voltage to a fourth node in response to a write gate signal, a third transistor which connects the third node and the fourth node in response to a compensation gate signal, a fourth transistor which applies a first reference voltage to the second node in response to a first emission signal, a fifth transistor which applies the sweep signal to the third node in response to a second emission signal and a first capacitor including a first electrode connected to the first node and a second electrode connected to the fourth node.

This application claims priority to Korean Patent Application No. 10-2024-0083021, filed on Jun. 25, 2024, and Korean Patent Application No. 10-2024-0153140, filed on Nov. 1, 2024, and all the benefits accruing therefrom under 35 U.S.C. § 119, the content of which in their entirety is herein incorporated by reference.

### BACKGROUND

### 1. Field

Embodiments of the inventive concept relate to a pixel circuit and a display device including the same. More particularly, embodiments of the inventive concept relate to the pixel circuit which is driven by pulse width modulation, performs internal compensation of threshold voltage, and includes a relatively small number of transistors, applicable to ultra-high resolution display apparatus.

### 2. Description of the Related Art

Generally, a display device includes a display panel and a display panel driver. The display panel includes a plurality of gate lines, a plurality of data lines, and a plurality of pixels. The display panel driver includes a gate driver providing a gate signal to the gate lines, a data driver providing a data voltage to the data lines, and a driving controller controlling the gate driver, and the data driver.

### SUMMARY

A conventional pixel circuit driven by pulse width modulation method and performing internal compensation of a threshold voltage may include nineteen or more transistors and three or more capacitors, so that it is difficult to apply it to an ultra-high-resolution display device due to limitations in integration.

Embodiments of the inventive concept provide a pixel circuit which is driven by pulse width modulation, performs internal compensation of threshold voltage, and includes a relatively small number of transistors, applicable to ultra-high resolution display device.

Embodiments of the inventive concept also provide a display device including the pixel circuit.

Embodiments of the inventive concept also provide an electronic device including the pixel circuit.

In an embodiment of the disclosure, a pixel circuit may include a first circuit block which outputs an emission control signal based on a sweep signal and a pulse data voltage, a second circuit block which outputs a driving current based on a pixel data voltage and the emission control signal and a light-emitting element which emits light based on the driving current. The first circuit block may include a first transistor including a control electrode connected to a first node, a first electrode connected to a second node and a second electrode connected to a third node, a second transistor which applies the pulse data voltage to a fourth node in response to a write gate signal, a third transistor which connects the third node and the fourth node in response to a compensation gate signal, a fourth transistor which applies a first reference voltage to the second node in response to a first emission signal, a fifth transistor which applies the sweep signal to the third node in response to a second emission signal and a first capacitor including a first electrode connected to the first node and a second electrode connected to the fourth node. The second node may output the emission control signal.

In an embodiment, the second circuit block may include an output transistor which outputs the emission control signal to a fifth node, a driving transistor which generates the driving current in response to a voltage of the fifth node and a write transistor which applies a second reference voltage to the fifth node in response to an initialization gate signal.

In an embodiment, the first transistor may be an N-type transistor, and the driving transistor may be a P-type transistor.

In an embodiment, the driving transistor may include a control electrode connected to the fifth node, a first electrode receiving a high power voltage having a relatively high power voltage level and a second electrode connected to a sixth node. The second circuit block may further include a compensation transistor which connects the fifth node and the sixth node in response to the compensation gate signal.

In an embodiment, a frame period in which the pixel circuit is driven may include first to seventh periods. In the first period, the initialization gate signal may have an activation level, and the second reference voltage may have an initialization voltage. In the first period, the write transistor may be turned on in response to the initialization gate signal.

In an embodiment, in the second period, the initialization gate signal may have an activation level, and the second reference voltage may have the pixel data voltage. In the first period, the pixel data voltage may be applied to the fifth node.

In an embodiment, in the third period, the compensation gate signal may have an activation level, and the first emission signal may have an activation level. In the third period, the compensation transistor may be turned on, the third transistor may be turned on, and the fourth transistor may be turned on.

In an embodiment, in the fourth period, the write gate signal may have an activation level. In the fourth period, the second transistor may be turned on.

In an embodiment, in the fifth period, the first emission signal may have the inactivation level, and the second emission signal may have an activation level.

In an embodiment, in the sixth period, the first emission signal may have an inactivation level, the second emission signal may have an activation level, and the sweep signal may be gradually decreased from a first sweep level to a second sweep level.

In an embodiment, in the seventh period, the output transistor may be turned on, the emission control signal may be applied to the fifth node, and the driving transistor may be turned off.

In an embodiment, a frame period in which the pixel circuit is driven may include a first frame period and a second frame period. The driving transistor may be turned on in the first frame period, and the driving transistor may be turned off in the second frame period. In an embodiment, in the first frame period, the second reference voltage may have the pixel data voltage or an initialization voltage. In the second frame period, the second reference voltage may maintain the initialization voltage.

In an embodiment, the second circuit block may include an output transistor which outputs the emission control signal to a fifth node, a driving transistor which generates the driving current in response to a voltage of the fifth node, a write transistor which applies a second reference voltage to the fifth node in response to the compensation gate signal and an initialization transistor which applies an initialization voltage to the fifth node in response to an initialization gate signal.

In an embodiment, the second circuit block may include a driving transistor including a control electrode connected to a fifth node, a first electrode connected to a sixth node and a second electrode connected to a seventh node, an output transistor which outputs the emission control signal to the seventh node, a write transistor which applies a second reference voltage to the fifth node in response to an initialization gate signal and a compensation capacitor including a first electrode connected to the sixth node and a second electrode connected to the fifth node.

In an embodiment, the first transistor may be an N-type transistor, and the driving transistor may be a P-type transistor.

In an embodiment, the second circuit block may further include an initialization transistor which applies an initialization voltage to the fifth node in response to the initialization gate signal.

In an embodiment, the pixel circuit may further include a light-emitting element initialization transistor. The light-emitting element may include a first electrode receiving the driving current and a second electrode receiving a low power voltage having a relatively low power voltage level. The light-emitting element initialization transistor may apply the low power voltage to the first electrode of the light emitting element in response to an initialization gate signal.

In an embodiment of the disclosure, a display device may include a display panel including a pixel circuit, a gate driver which outputs gate signals to the pixel circuit, a sweep signal outputter which outputs a sweep signal to the pixel circuit, a data driver which applies a pulse data voltage and a pixel data voltage to the pixel circuit and a driving controller which controls the gate driver, the sweep signal outputter and the data driver. The pixel circuit may include a first circuit block which outputs an emission control signal based on the sweep signal and the pulse data voltage, a second circuit block which outputs a driving current based on the pixel data voltage and the emission control signal and a light-emitting element which emits light based on the driving current. The first circuit block may include a first transistor including a control electrode connected to a first node, a first electrode connected to a second node and a second electrode connected to a third node, a second transistor which applies the pulse data voltage to a fourth node in response to a write gate signal of the gate signals, a third transistor which connects the third node and the fourth node in response to a compensation gate signal of the gate signals, a fourth transistor which applies a first reference voltage to the second node in response to a first emission signal, a fifth transistor which applies the sweep signal to the third node in response to a second emission signal and a first capacitor including a first electrode connected to the first node and a second electrode connected to the fourth node. The second node may output the emission control signal.

In an embodiment, the second circuit block may include an output transistor which outputs the emission control signal to a fifth node, a driving transistor which generates the driving current in response to a voltage of the fifth node and a write transistor which applies a second reference voltage to the fifth node in response to an initialization gate signal of the gate signals. The first transistor may be an N-type transistor, and the driving transistor may be a P-type transistor.

In an embodiment of the disclosure, an electronic device may include a display panel including a pixel circuit, a gate driver which outputs gate signals to the pixel circuit, a sweep signal outputter which outputs a sweep signal to the pixel circuit, a data driver which applies a pulse data voltage and a pixel data voltage to the pixel circuit, a driving controller which controls the gate driver, the sweep signal outputter and the data driver based on an input control signal and a processor which outputs the input control signal. The pixel circuit may include a first circuit block which outputs an emission control signal based on the sweep signal and the pulse data voltage, a second circuit block which outputs a driving current based on the pixel data voltage and the emission control signal and a light-emitting element which emits light based on the driving current. The first circuit block may include a first transistor including a control electrode connected to a first node, a first electrode connected to a second node and a second electrode connected to a third node, a second transistor which applies the pulse data voltage to a fourth node in response to a write gate signal of the gate signals, a third transistor which connects the third node and the fourth node in response to a compensation gate signal of the gate signals, a fourth transistor which applies a first reference voltage to the second node in response to a first emission signal, a fifth transistor which applies the sweep signal to the third node in response to a second emission signal and a first capacitor including a first electrode connected to the first node and a second electrode connected to the fourth node. The second node may output the emission control signal.

In an embodiment, the second circuit block may include an output transistor which outputs the emission control signal to a fifth node, a driving transistor which generates the driving current in response to a voltage of the fifth node and a write transistor which applies a second reference voltage to the fifth node in response to an initialization gate signal of the gate signals. The first transistor may be an N-type transistor, and the driving transistor may be a P-type transistor.

As described above, a first circuit block included in a pixel circuit may generate the emission control signal based on the sweep signal and the pulse data voltage, and a first circuit block included in a pixel circuit may control a generation of the driving current based on the emission control signal. Accordingly, an emitting time in which the light-emitting element emits light may be controlled based on the pulse data voltage. Accordingly, a grayscale of the display panel may be controlled.

Additionally, the display device may perform internal compensation of threshold voltage, and include a relatively small number of transistors. Accordingly, an integration of the pixel circuit may be improved.

Additionally, a transistor generating the emission control signal may be an N-type transistor. Accordingly, a hysteresis characteristic of the transistor generating the emission control signal may be improved. Accordingly, a reliability of the emission control signal may be improved. The reliability of the emission control signal may be improved, so that a display quality of the display panel may be improved.

Additionally, the first circuit block may perform an internal compensating method which is source-follower method. Accordingly, when the transistor generating the emission control signal included in the first circuit block is an N-type transistor, a reliability of a compensation may be improved.

Additionally, a driving transistor included in the second circuit block may be a P-type transistor. Accordingly, a reliability of the driving current may be improved. The reliability of the driving current may be improved, so that an emission efficiency of the light-emitting element may be improved. Additionally, a display quality of the display panel may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating an embodiment of a display device according to the inventive concept.

FIG. 2 is a block diagram illustrating an embodiment of a pixel circuit of FIG. 1.

FIG. 3 is a circuit diagram illustrating an embodiment of a pixel circuit of FIG. 2.

FIG. 4 is a timing diagram illustrating signals applied to a pixel circuit of FIG. 3.

FIG. 5 is a circuit diagram illustrating an operation of a pixel circuit of FIG. 3 in a first period of FIG. 4.

FIG. 6 is a circuit diagram illustrating an operation of a pixel circuit of FIG. 3 in a second period of FIG. 4.

FIG. 7 is a circuit diagram illustrating an operation of a pixel circuit of FIG. 3 in a third period of FIG. 4.

FIG. 8 is a circuit diagram illustrating an operation of a pixel circuit of FIG. 3 in a fourth period of FIG. 4.

FIG. 9 is a circuit diagram illustrating an operation of a pixel circuit of FIG. 3 in a fifth period and a sixth period of FIG. 4.

FIG. 10 is a circuit diagram illustrating an operation of a pixel circuit of FIG. 3 in a seventh period of FIG. 4.

FIG. 11 is a circuit diagram illustrating an embodiment of a pixel circuit of FIG. 2.

FIG. 12 is a conceptual diagram illustrating frame periods and in which a pixel circuit of FIG. 3 is driven.

FIG. 13 is a timing diagram illustrating signals applied to a pixel circuit of FIG. 3 in a second frame period of FIG. 12.

FIG. 14 is a circuit diagram illustrating an operation of a pixel circuit of FIG. 3 in a second frame period of FIG. 12

FIG. 15 is a circuit diagram illustrating an embodiment of a pixel circuit of FIG. 2.

FIG. 16 is a timing diagram illustrating signals applied to a pixel circuit of FIG. 15.

FIG. 17 is a circuit diagram illustrating an operation of a pixel circuit of FIG. 15 in a first period of FIG. 16.

FIG. 18 is a circuit diagram illustrating an operation of a pixel circuit of FIG. 15 in a second period of FIG. 16.

FIG. 19 is a circuit diagram illustrating an operation of a pixel circuit of FIG. 15 in a third period of FIG. 16.

FIG. 20 is a circuit diagram illustrating an operation of a pixel circuit of FIG. 15 in a fourth period of FIG. 16.

FIG. 21 is a circuit diagram illustrating an operation of a pixel circuit of FIG. 15 in a fifth period and a sixth period of FIG. 16.

FIG. 22 is a circuit diagram illustrating an operation of a pixel circuit of FIG. 15 in a seventh period of FIG. 16.

FIG. 23 is a circuit diagram illustrating an embodiment of a pixel circuit of FIG. 2.

FIG. 24 is a block diagram illustrating an embodiment of an electronic device according to the inventive concept.

FIG. 25 is a diagram illustrating an embodiment in which the electronic device of FIG. 24 is implemented as a smart phone.

### DETAILED DESCRIPTION OF THE INVENTIVE CONCEPT

Hereinafter, the inventive concept will be explained in detail with reference to the accompanying drawings.

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the disclosure to those skilled in the art. Like reference numerals refer to like elements throughout.

It will be understood that when an element is referred to as being “on” another element, it may be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” may therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” may, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within ±30%, 20%, 10%, 5% of the stated value, for example.

The terms such as “processor” and “outputter” as used herein are intended to mean a hardware component such as a circuitry that performs a predetermined function. The hardware component may include a field-programmable gate array (“FPGA”) or an application-specific integrated circuit (“ASIC”), for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

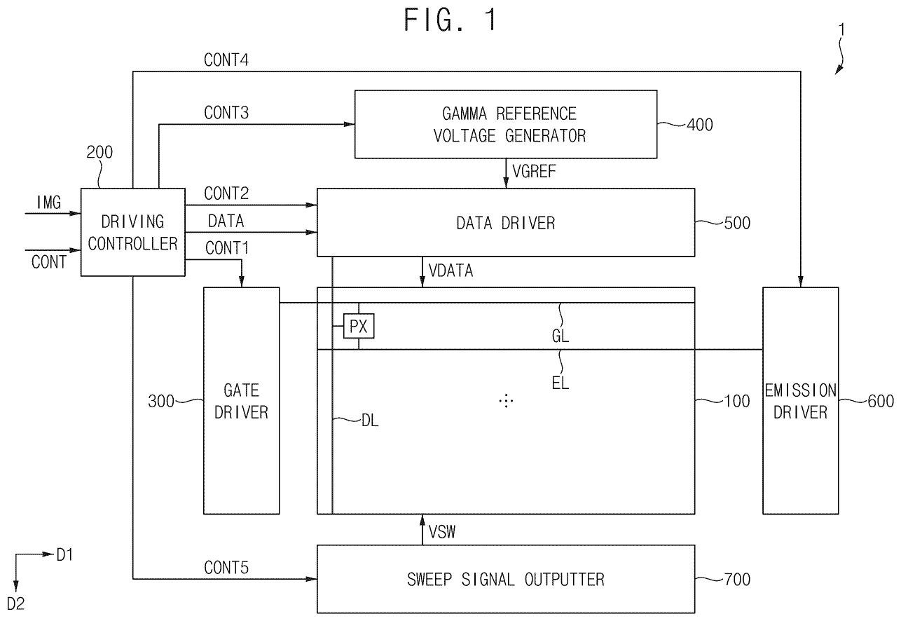

FIG. 1 is a block diagram illustrating an embodiment of a display device 1 according to the inventive concept.

Referring to FIG. 1, the display device 1 may include a display panel 100 and a display panel driver. The display panel driver may include a driving controller 200, a gate driver 300, a gamma reference voltage generator 400, a data driver 500 and an emission driver 600. In an embodiment, the display device 1 may further include a sweep signal outputter 700.

The display panel 100 may include a display region displaying an image and a peripheral region disposed next (adjacent) to the display region.

The display panel 100 may include a plurality of gate lines, a plurality of data lines DL, a plurality of emission lines EL and a plurality of pixel PX electrically connected to the gate lines GL, the data lines DL and the emission lines EL. The gate lines GL may extend in a first direction D1 and the data lines DL may extend in a second direction D2 crossing the first direction D1. The emission lines EL may extend in a first direction D1.

The driving controller 200 may receive input image data IMG and an input control signal CONT from an external device. In an embodiment, the input image data IMG may include red image data, green image data and blue image data. The input image data IMG may include white image data, for example. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 may generate a first control signal CONT1, a second control signal CONT2, a third control signal CONT3, a fourth control signal CONT4 and a data signal DATA based on the input image data IMG and the input control signal CONT. In an embodiment, the driving controller 200 may further generate a fifth control signal CONT5.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT and output the third control signal CONT3 to the gamma reference voltage generator 400.

The driving controller 200 may generate the fourth control signal CONT4 for controlling an operation of the emission driver 600 based on the input control signal CONT, and output the fourth control signal CONT4 to the emission driver 600.

In an embodiment, the driving controller 200 may generate the fifth control signal CONT5 for controlling an operation of the sweep signal outputter 700 based on the input control signal CONT, and output the fifth control signal CONT5 to the sweep signal outputter 700.

The gate driver 300 generates gate signals driving the gate lines GL in response to the first control signal CONT1 received from the driving controller 200. The gate driver 300 may output the gate signals to the gate lines GL.

In an embodiment, the gate driver 300 may be disposed in the peripheral region. In an embodiment, the gate driver 300 may be integrated in the peripheral region.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500, for example.

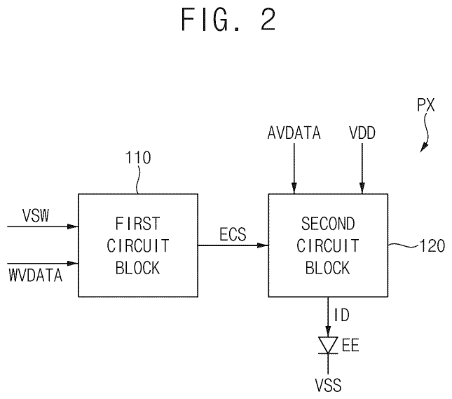

The data driver 500 receives the second control signal CONT2 and the data signal DATA from the driving controller 200, and receives the gamma reference voltages VGREF from the gamma reference voltage generator 400. The data driver 500 converts the data signal DATA into analog type of data voltages using the gamma reference voltages VGREF. In an embodiment, the analog type of data voltages VDATA may be a pulse data voltage WVDATA of FIG. 2.

In an embodiment, the data driver 500 may be disposed in the peripheral region. In an embodiment, the data driver 500 may be integrated in the peripheral region.

The emission driver 600 generates an emission signal driving the emission lines EL in response to the fourth control signal CONT4 received from the driving controller 200. The emission driver 600 may output the emission signal to the emission lines EL.

In an embodiment, the emission driver 600 may be disposed in the peripheral region. In an embodiment, the emission driver 600 may be integrated in the peripheral region.

Although the gate driver 300 is disposed on a first side of the display panel 100, and the emission driver 600 is disposed on a second side of the display panel 100 in FIG. 1 for convenience of explanation, the inventive concept is not limited thereto. The gate driver 300 and the emission driver 600 may be disposed on the first side of the display panel 100. In an embodiment, the gate driver 300 and the emission driver 600 may be disposed on the peripheral region of the display panel 100 on the same side of the display region of the display panel 100, for example. In an embodiment, the gate driver 300 and the emission driver 600 may be formed integrally with each other, for example.

The sweep signal outputter 700 may generate the sweep signal VSW in response to the fifth control signal CONT5 received from the driving controller 200. The sweep signal outputter 700 may output the sweep signal VSW to the display panel 100. In an embodiment, the sweep signal VSW may be gradually decreased from a first sweep level to a second sweep level, for example. In an embodiment, the sweep signal VSW may be gradually increased from the second sweep level to the first sweep level, for example.

FIG. 2 is a block diagram illustrating an embodiment of a pixel circuit PX of FIG. 1.

Referring to FIG. 1 and FIG. 2, the pixel circuit PX may include a first circuit block 110, a second circuit block 120 and a light-emitting element EE.

The first circuit block 110 may receive the sweep signal VSW and the pulse data voltage WVDATA. The first circuit block 110 may output an emission control signal ECS based on the sweep signal VSW and the pulse data voltage WVDATA. In an embodiment, the first circuit block 110 may be referred to as a pulse signal applier, for example.

The second circuit block 120 may generate a driving current ID based on a pixel data voltage AVDATA and a high power voltage VDD having a relatively low power voltage level. The second circuit block 120 may output the driving current ID to the light-emitting element EE. The second circuit block 120 may stop generating the driving current ID in response to the emission control signal ECS. The second circuit block 120 may stop outputting the driving current ID in response to the emission control signal ECS. The light-emitting element EE may stop emitting light in response to the emission control signal ECS. In an embodiment, the second circuit block 120 may be referred to as a constant current applier, for example.

The light-emitting element EE may include a first electrode receiving the driving current ID and a second electrode receiving a low power voltage VSS having a relatively low power voltage level. The light-emitting element EE may emit light based on the driving current ID.

In the illustrated embodiment, a time in which the light-emitting element EE emits light may be controlled based on the pulse data voltage WVDATA. Accordingly, a grayscale of the display panel 100 may be controlled. The control method may be a pulse width modulation.

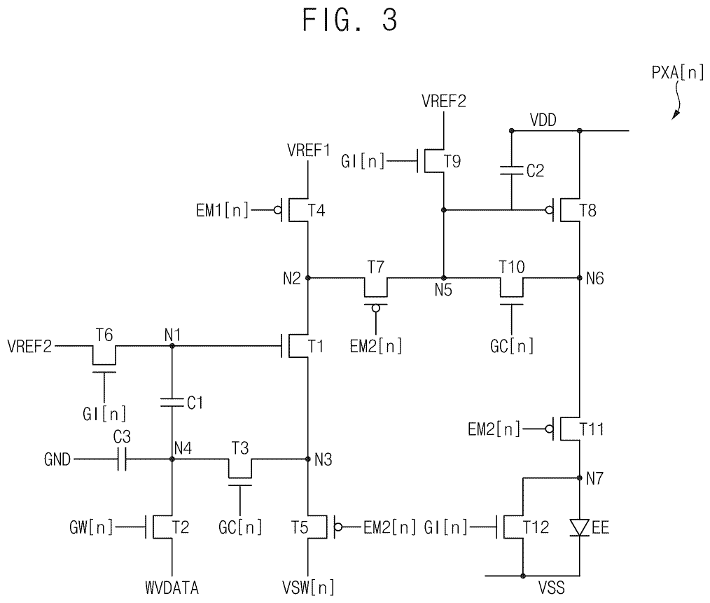

FIG. 3 is a circuit diagram illustrating an embodiment of a pixel circuit PXA[n] of FIG. 2.

Referring to FIG. 1 to FIG. 3, a pixel circuit PXA[n] may include first to twelfth transistors T1, T2, T3, T4, T5, T6, T7, T8, T9, T10, T11 and T12, first to third capacitors C1, C2 and C3 and the light-emitting element EE. The display panel 100 may include a plurality of pixel-rows. The pixel circuit PXA[n] may be included in an N-th pixel-row of the pixel-rows.

The first circuit block 110 may include the first to seventh transistors T1, T2, T3, T4, T5, T6 and T7. The second circuit block 120 may include the eighth to twelfth transistors T8, T9, T10, T11 and T12.

The first transistor T1 may include a control electrode connected to a first node N1, a first electrode connected to a second node N2 and a second electrode connected to a third node N3. The first transistor T1 may connect the second node N2 and the third node N3 in response to a voltage of the first node N1. In an embodiment, the first transistor T1 may be an N-type transistor.

The second transistor T2 may include a control electrode receiving a write gate signal GW[n], a first electrode receiving the pulse data voltage WVDATA and a second electrode connected to a fourth node N4. The second transistor T2 may apply the pulse data voltage WVDATA to the fourth node N4 in response to a write gate signal GW[n].

The third transistor T3 may include a control electrode receiving a compensation gate signal GC[n], a first electrode connected to the third node N3 and a second electrode connected to the fourth node. The third transistor T3 may connect the third node N3 and the fourth node N4 in response to the compensation gate signal GC[n].

The fourth transistor T4 may include a control electrode receiving a first emission signal EM1[n], a first electrode receiving a first reference voltage VREF1 and a second electrode connected to the second node N2. The fourth transistor T4 may apply the first reference voltage VREF1 to the second node N2 in response to the first emission signal EM1[n].

The fifth transistor T5 may include a control electrode receiving a second emission signal EM2[n], a first electrode receiving the sweep signal VSW[n] and a second electrode connected to the third node N3. The fifth transistor T5 may apply the sweep signal VSW[n] to the third node N3 in response to the second emission signal EM2[n].

The sixth transistor T6 may include a control electrode receiving an initialization gate signal GI[n], a first electrode receiving a second reference voltage VREF2 and a second electrode connected to the first node N1. The sixth transistor T6 may apply the second reference voltage VREF2 to the first node N1 in response to the initialization gate signal GI[n].

The seventh transistor T7 may include a control electrode receiving the second emission signal EM2[n], a first electrode connected to the second node N2 and a second electrode connected to the fifth node N5. The seventh transistor T7 may connect the second node N2 and the fifth node N5 in response to a voltage difference between an activation level of the second emission signal EM2[n] and a voltage of the second node N2. The seventh transistor T7 may output the emission control signal ECS to the fifth node N5. In an embodiment, the second node N2 may output the emission control signal ECS, for example. In an embodiment, a voltage of the second node N2 may be the emission control signal ECS, for example.

The eighth transistor T8 may include a control electrode connected to the fifth node N5, a first electrode receiving the high power voltage VDD and a second electrode connected to a sixth node N6. The eighth transistor T8 may generate the driving current ID based on a voltage of the fifth node N5. The eighth transistor T8 may output the driving current ID. In an embodiment, the eighth transistor T8 may be referred to as a driving transistor. In an embodiment, the eighth transistor T8 may be a P-type transistor, for example.

The ninth transistor T9 may include a control electrode receiving the initialization gate signal GI[n], a first electrode receiving the second reference voltage VREF2 and a second electrode connected to the fifth node N5. The ninth transistor T9 may apply the second reference voltage VREF2 to the fifth node N5 in response to the initialization gate signal GI[n]. In an embodiment, the ninth transistor T9 may be referred to as a write transistor, for example.

The tenth transistor T10 may include a control electrode receiving the compensation gate signal GC[n], a first electrode connected to the sixth node N6 and a second electrode connected to the fifth node N5. The tenth transistor T10 may connect the fifth node N5 and the sixth node N6 in response to the compensation gate signal GC[n]. In an embodiment, the tenth transistor T10 may diode-connect the eighth transistor T8, for example. In an embodiment, the tenth transistor T10 may be referred to as a compensation transistor, for example.

The eleventh transistor T11 may include a control electrode receiving the second emission signal EM2[n], a first electrode connected to the sixth node N6 and a second electrode connected to a seventh node N7. The eleventh transistor T11 may connect the sixth node N6 and the seventh node N7 in response to the second emission signal EM2[n]. The eleventh transistor T11 may output the driving current ID to the seventh node N7 in response to the second emission signal EM2[n].

The twelfth transistor T12 may include a control electrode receiving the initialization gate signal GI[n], a first electrode receiving the low power voltage VSS and a second electrode connected to the seventh node N7. The twelfth transistor T12 may apply the low power voltage VSS to the seventh node N7 in response to the initialization gate signal GI[n]. Accordingly, a black characteristic of the pixel circuit PXA[n] may be improved. In an embodiment, the twelfth transistor T12 may be referred to as a light-emitting element initialization transistor, for example.

The first capacitor C1 may include a first electrode connected to the first node N1 and a second electrode connected to the fourth node N4. The second capacitor C2 may include a first electrode receiving the high power voltage VDD and a second electrode connected to the fifth node N5. The third capacitor C3 may include a first electrode connected to the fourth node N4 and a second electrode receiving a ground voltage GND. The light-emitting element EE may include a control electrode connected to the seventh node N7 and a second electrode receiving the low power voltage VSS.

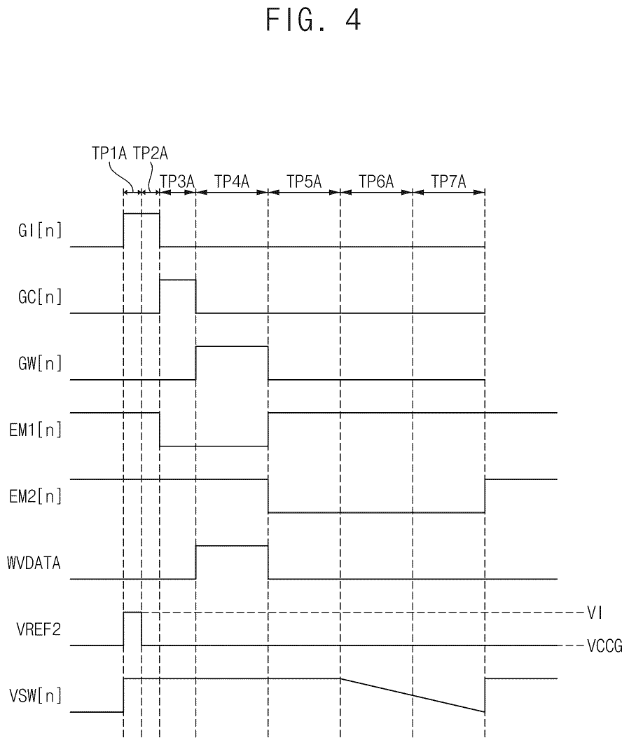

FIG. 4 is a timing diagram illustrating signals applied to a pixel circuit PXA[n] of FIG. 3.

Referring to FIG. 1 to FIG. 4, a frame period in which the pixel circuit PXA[n] is driven may include first to seventh periods TP1A, TP2A, TP3A, TP4A, TP5A, TP6A and TP7A.

In the illustrated embodiment, an activation level of the initialization gate signal GI[n] may be a logic high level. An inactivation level of the initialization gate signal GI[n] may be a logic low level. An activation level of the compensation gate signal GC[n] may be a logic high level. An inactivation level of the compensation gate signal GC[n] may be a logic low level. An activation level of the write gate signal GW[n] may be a logic high level. An inactivation level of the write gate signal GW[n] may be a logic low level. An activation level of the first emission signal EM1[n] may be a logic high level. An inactivation level of the first emission signal EM1[n] may be a logic low level. An activation level of the second emission signal EM2[n] may be a logic high level. An inactivation level of the second emission signal EM2[n] may be a logic low level. The sweep signal VSW[n] may be gradually decreased from a first sweep level to a second sweep level. In the illustrated embodiment, the first sweep level of the sweep signal VSW[n] may have a relatively high voltage. In an embodiment, the first sweep level may have a voltage having a positive value, for example. In the illustrated embodiment, the second sweep level may have a relatively low voltage. In an embodiment, the second sweep level may have a voltage having one of a relatively low positive value lower than the positive value of the first sweep level, a zero value and a negative value, for example.

In the illustrated embodiment, the second reference voltage VREF2 may be an alternating current (“AC”) voltage. In an embodiment, the second reference voltage VREF2 may have an initialization voltage VI or a constant current voltage VCCG, for example. The initialization voltage VI may be a voltage such that the driving transistor is turned off. The constant current voltage VCCG may be a voltage for generating the driving current. In an embodiment, the constant current voltage VCCG may have a voltage level of the same magnitude for all pixels, for example. The constant current voltage VCCG may have a first voltage level for a red pixel, a second voltage level different from the first voltage level for a green pixel and a third voltage level different from the first voltage level and the second voltage level for a blue pixel. In an embodiment, the constant current voltage VCCG may be referred to as a pixel data voltage AVDATA, for example.

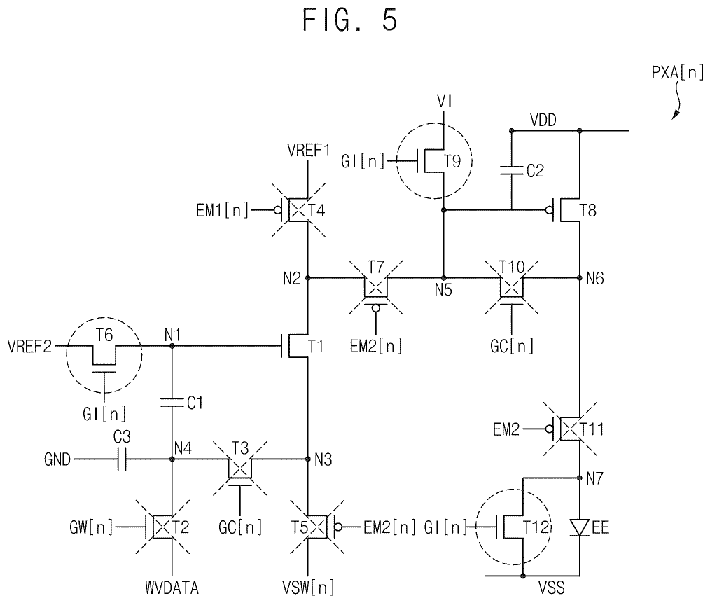

FIG. 5 is a circuit diagram illustrating an operation of a pixel circuit PXA[n] of FIG. 3 in a first period TP1A of FIG. 4.

Referring to FIG. 1 to FIG. 5, in the first period TP1A, the initialization gate signal GI[n] may have an activation level, the compensation gate signal GC[n] may have an inactivation level, the write gate signal GW[n] may have an inactivation level, the first emission signal EM1[n] may have an inactivation level, the second emission signal EM2[n] may have an inactivation level and the second reference voltage VREF2 may have the initialization voltage VI.

In the first period TP1A, the sixth transistor T6 may be turned on in response to the initialization gate signal GI[n]. Accordingly, the initialization voltage VI may be applied to the first node N1. In the first period TP1A, the first node N1 may be initialized as the initialization voltage VI. In the first period TP1A, the ninth transistor T9 may be turned on in response to the initialization gate signal GI[n]. The ninth transistor T9 may be turned on, so that the initialization voltage VI may be applied to the fifth node N5. In the first period TP1A, the fifth node N5 may be initialized as the initialization voltage VI. In the first period TP1A, the twelfth transistor T12 may be turned on in response to the initialization gate signal GI[n].

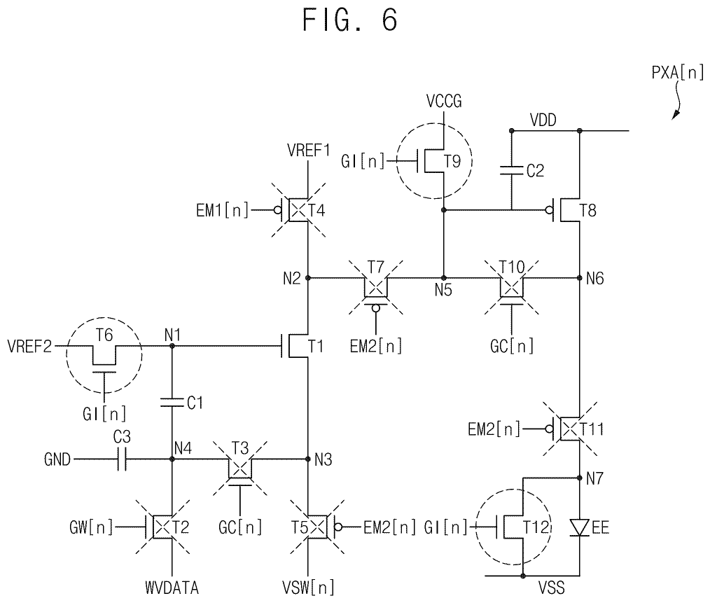

FIG. 6 is a circuit diagram illustrating an operation of a pixel circuit PXA[n] of FIG. 3 in a second period TP2A of FIG. 4.

Referring to FIG. 1 to FIG. 4 and FIG. 6, in the second period TP2A, the initialization gate signal GI[n] may have an activation level, the compensation gate signal GC[n] may have an inactivation level, the write gate signal GW[n] may have an inactivation level, the first emission signal EM1[n] may have an inactivation level, the second emission signal EM2[n] may have an inactivation level and the second reference voltage VREF2 may have the constant current voltage VCCG.

In the second period TP2A, the second reference voltage VREF2 may have the constant current voltage VCCG. In the second period TP2A, the constant current voltage VCCG may applied to the fifth node N5.

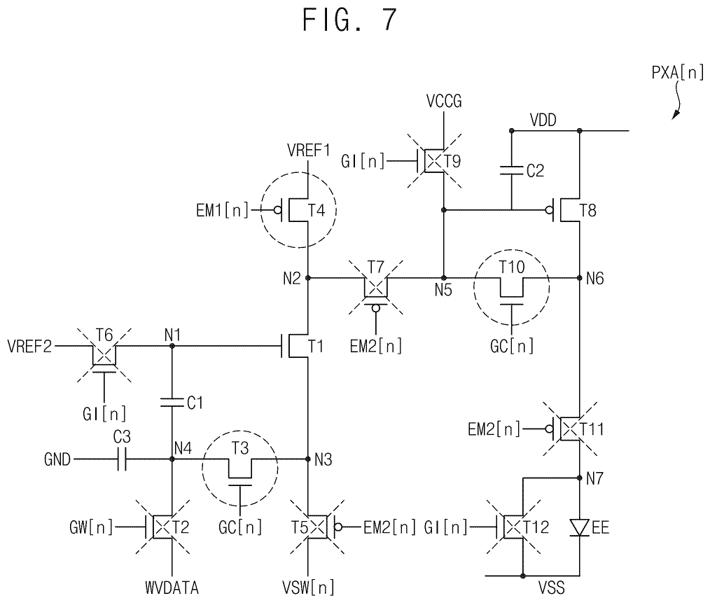

FIG. 7 is a circuit diagram illustrating an operation of a pixel circuit PXA[n] of FIG. 3 in a third period TP3A of FIG. 4.

Referring to FIG. 1 to FIG. 4 and FIG. 7, in the third period TP3A, the initialization gate signal GI[n] may have an inactivation level, the compensation gate signal GC[n] may have an activation level, the write gate signal GW[n] may have an inactivation level, the first emission signal EM1[n] may have an activation level, the second emission signal EM2[n] may have an inactivation level and the second reference voltage VREF2 may have the constant current voltage VCCG.

In the third period TP3A, the fourth transistor T4 may be turned on in response to the first emission signal EM1[n]. The fourth transistor T4 may be turned on, so that the first reference voltage VREF1 may be applied to the second node N2. In the illustrated embodiment, the first reference voltage VREF1 may have a reference low voltage. The reference low voltage may have a voltage having a negative value. In the third period TP3A, the third node N3 may may have the second sweep level. In the third period TP3A, the first transistor T1 may be turned on based on a voltage difference between the first node N1 and the third node N3. In the third period TP3A, the third transistor T3 may be turned on in response to the compensation gate signal GC[n]. The third transistor T3 may be turned on, so that the third node N3 and the fourth node N4 may be connected. The fourth transistor T4, the first transistor T1 and the third transistor T3 may be turned on, so that the first reference voltage VREF1 may be applied to the fourth node N4. Accordingly, the fourth node N4 may be initialized as the first reference voltage VREF1.

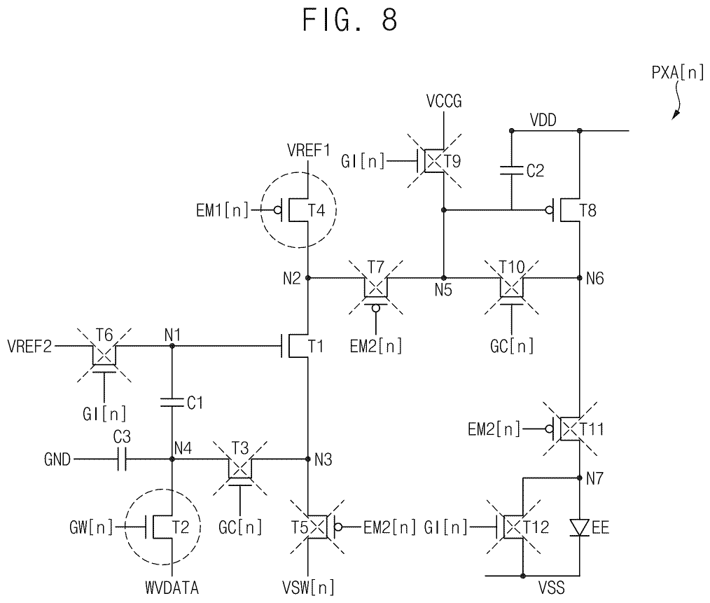

FIG. 8 is a circuit diagram illustrating an operation of a pixel circuit PXA[n] of FIG. 3 in a fourth period TP4A of FIG. 4.

Referring to FIG. 1 to FIG. 4 and FIG. 8, in the fourth period TP4A, the initialization gate signal GI[n] may have an inactivation level, the compensation gate signal GC[n] may have an inactivation level, the write gate signal GW[n] may have an activation level, the first emission signal EM1[n] may have an activation level, the second emission signal EM2[n] may have an inactivation level and the second reference voltage VREF2 may have the constant current voltage VCCG.

In the fourth period TP4A, the second transistor T2 may be turned on in response to the write gate signal GW[n]. The second transistor T2 may be turned on, so that the pulse data voltage WVDATA may be applied to the fourth node N4. The pulse data voltage WVDATA may be applied to the fourth node N4, so that a coupling voltage corresponding to the pulse data voltage WVDATA may be applied to the first node N1.

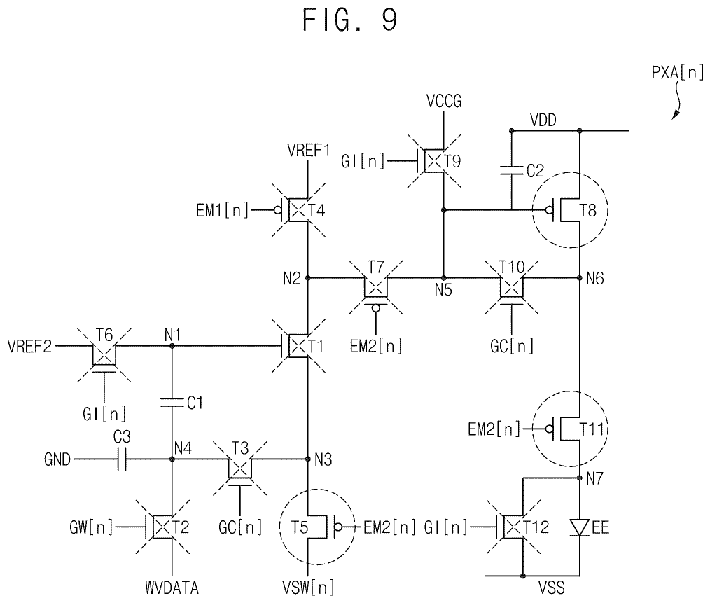

FIG. 9 is a circuit diagram illustrating an operation of a pixel circuit PXA[n] of FIG. 3 in a fifth period TP5A and a sixth period TP6A of FIG. 4.

Referring to FIG. 1 to FIG. 4 and FIG. 9, in the fifth period TP5A, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level and the second reference voltage VREF2 may have the constant current voltage VCCG.

In the sixth period TP6A, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level, the second reference voltage VREF2 may have the constant current voltage VCCG and the sweep signal VSW[n] may be gradually decreased from a first sweep level. In an embodiment, the sixth period TP6A may be referred to as an emission period, for example.

In the sixth period TP6A, the tenth transistor T10 may be turned on in response to the second emission signal EM2[n]. Accordingly, the driving current ID may be applied to the light-emitting element EE. The light-emitting element EE may emit light based on the driving current ID. In the sixth period TP6A, the fifth transistor T5 may be turned on in response to the second emission signal EM2[n]. The fifth transistor T5 may be turned on, so that the sweep signal VSW[n] may be applied to the third node N3. The sweep signal VSW[n] may be applied to the third node N3, so that a voltage of the third node N3 may be gradually decreased. In the sixth period TP6A, an absolute value of a voltage difference between an activation level the second emission signal EM2[n] and a voltage of the second node N2 may be lower than an absolute value of a threshold voltage of the seventh transistor T7. Accordingly, in the sixth period TP6A, the seventh transistor T7 may be turned off.

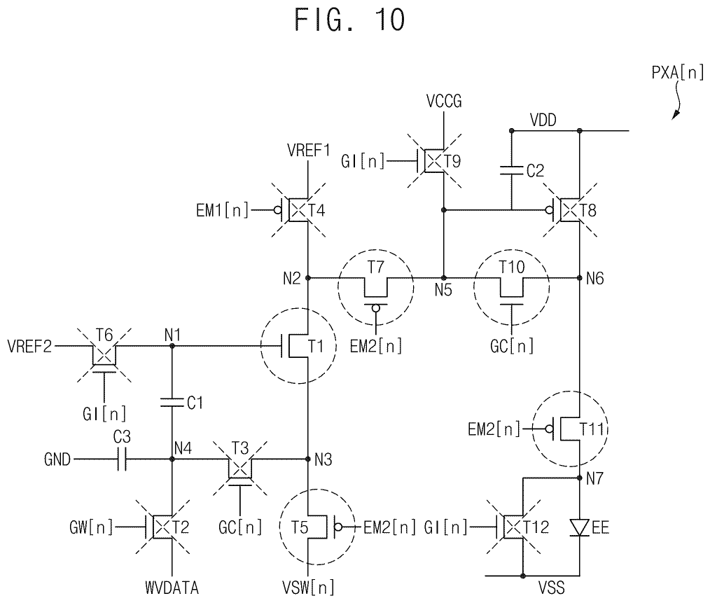

FIG. 10 is a circuit diagram illustrating an operation of a pixel circuit PXA[n] of FIG. 3 in a seventh period TP7A of FIG. 4.

Referring to FIG. 1 to FIG. 4 and FIG. 10, in the seventh period TP7A, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level, the second reference voltage VREF2 may have the constant current voltage VCCG and the sweep signal VSW[n] may be gradually decreased from a first sweep level to the second sweep level. In an embodiment, the seventh period TP7A may be referred to as an emission-off period, for example.

In the seventh period TP7A, a voltage of the third node N3 may be gradually decreased, so that the voltage difference between a voltage of the first node N1 and a voltage of the third node N3 may be higher than a threshold voltage of the first transistor T1. Accordingly, the first transistor T1 may be turned on. Accordingly, the sweep signal VSW[n] may be applied to the second node N2. The sweep signal VSW[n] may be applied to the second node N2, so that the second node N2 may have a voltage higher than the first reference voltage VREF1. Accordingly, an absolute value of a voltage difference between an activation level of the second emission signal EM2[n] and a voltage of the second node N2 may be higher than an absolute value of a threshold voltage of the seventh transistor T7. Accordingly, the seventh transistor T7 may be turned on. The seventh transistor T7 may be turned on, so that the emission control signal ECS may be applied to the fifth node N5. The emission control signal ECS may be higher than a threshold voltage of the eighth transistor T8. Accordingly, the eighth transistor T8 may be turned off. The eighth transistor T8 may be turned off, so that the driving current ID may not be applied to the light-emitting element EE. Accordingly, the light-emitting element EE may stop emitting.

In the illustrated embodiment, the emission control signal ECS may be generated based on the sweep signal VSW[n] and the pulse data voltage WVDATA, and generation of the driving current ID may be controlled based on the emission control signal ECS. Accordingly, an emitting time in which the light-emitting element EE emits light may be controlled based on the pulse data voltage WVDATA. Accordingly, a grayscale of the display panel 100 may be controlled. The control method may be a pulse width modulation.

Additionally, in the illustrated embodiment, the display device 1 may perform internal compensation of threshold voltage, and include a relatively small number of transistors. Accordingly, an integration of the pixel circuit PXA[n] may be improved.

Additionally, in the illustrated embodiment, the first transistor T1 may be an N-type transistor. Accordingly, a hysteresis characteristic of the first circuit block 110 may be improved. Accordingly, a reliability of the emission control signal ECS may be improved. The reliability of the emission control signal ECS may be improved, so that a display quality of the display panel 100 may be improved.

Additionally, in the illustrated embodiment, the first circuit block 110 may perform an internal compensating method which is source-follower method. Accordingly, when the first transistor T1 included in the first circuit block 110 is an N-type transistor, a reliability of a compensation may be improved.

Additionally, in the illustrated embodiment, the eighth transistor T8 may be a P-type transistor. Accordingly, a reliability of the driving current ID may be improved. The reliability of the driving current ID may be improved, so that an emission efficiency of the light-emitting element EE may be improved. Additionally, a display quality of the display panel 100 may be improved.

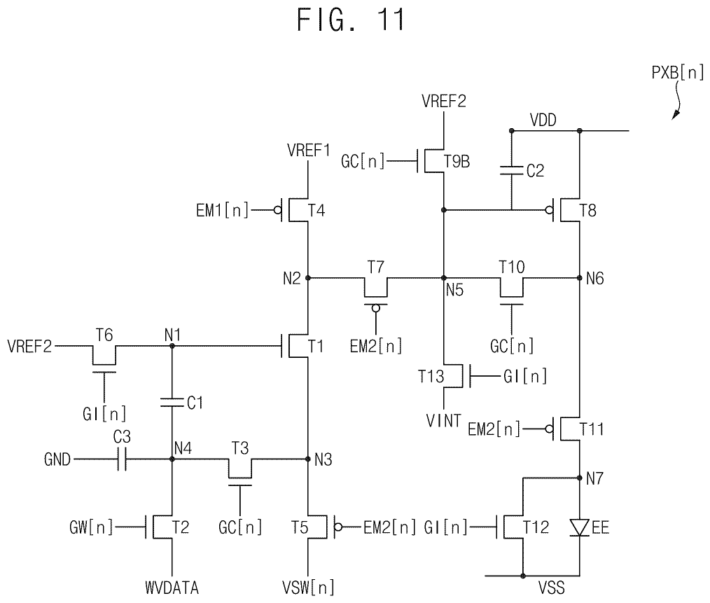

FIG. 11 is a circuit diagram illustrating an embodiment of a pixel circuit PX of FIG. 2.

Referring to FIG. 11, a pixel circuit PXB[n] may include first transistor to thirteenth transistors T1, T2, T3, T4, T5, T6, T7, T8, T9B, T10, T11, T12 and T13, the first to third capacitors C1, C2 and C3 and the light-emitting element EE. Here, n is a natural number. The display panel 100 may include a plurality of pixel-rows. The pixel circuit PXB[n] may be included in an N-th pixel-row of the pixel-rows. Here, N is a natural number greater than 1.

The pixel circuit PXB[n] of FIG. 11 is substantially same as the pixel circuit PXA[n] of FIG. 3 except that the pixel circuit PXB[n] further includes the thirteenth transistor T13, and the ninth transistor T9B receives the compensation gate signal GC[n], so that the same reference numerals will be used and any repetitive explanation concerning the above elements will be omitted.

In the illustrated embodiment, the ninth transistor T9 may be turned on in response to the compensation gate signal GC[n]. The thirteenth transistor T13 may include a control electrode receiving the initialization gate signal GI[n], a first electrode receiving an initialization voltage VINT and a second electrode connected to the fifth node N5. The thirteenth transistor T13 may apply the initialization voltage VINT to the fifth node N5 in response to the initialization gate signal GI[n].

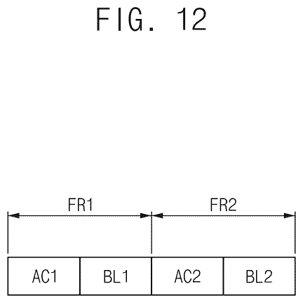

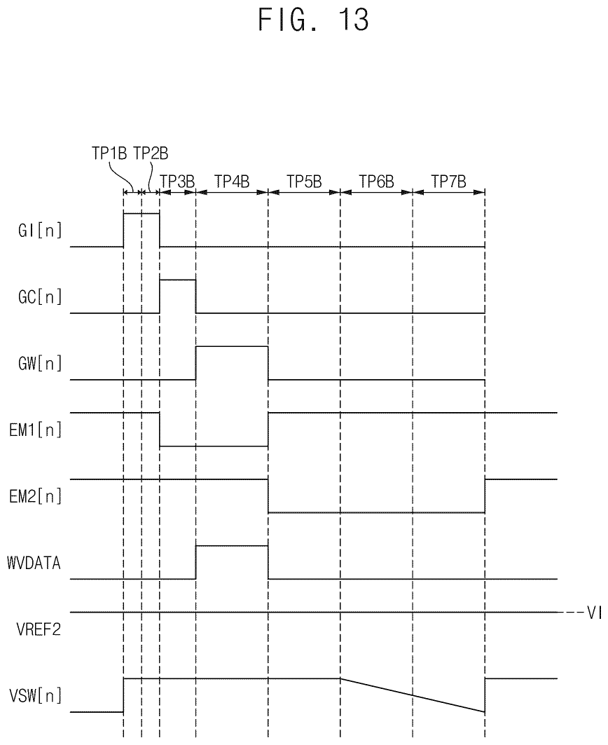

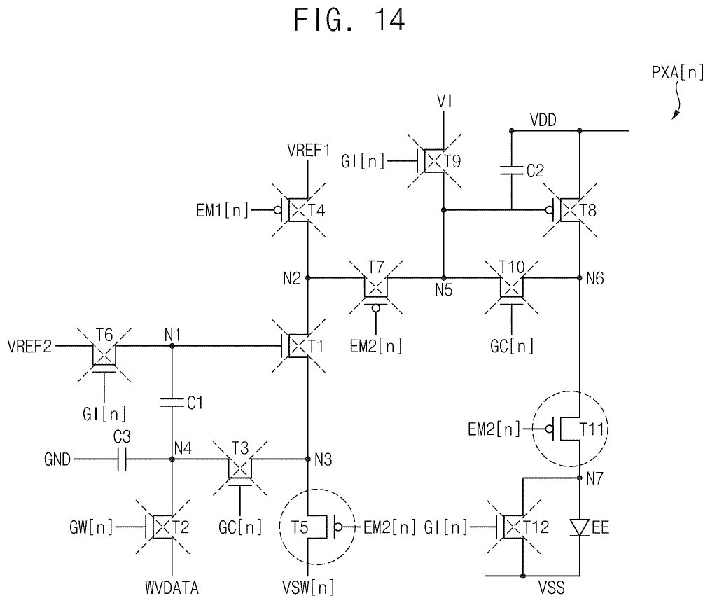

FIG. 12 is a conceptual diagram illustrating frame periods FR1 and FR2 in which a pixel circuit PXA[n] of FIG. 3 is driven. FIG. 13 is a timing diagram illustrating signals applied to a pixel circuit PXA[n] of FIG. 3 in a second frame period FR2 of FIG. 12. FIG. 14 is a circuit diagram illustrating an operation of a pixel circuit PXA[n] of FIG. 3 in a second frame period FR2 of FIG. 12

Referring to FIG. 1 to FIG. 14, in the illustrated embodiment, the display panel 100 may be driven as a variable frequencies. In an embodiment, when the driving frequency in which the display panel 100 is driven is decreased, in a second frame period FR2 following to a first frame period FR1, the second reference voltage VREF2 may maintain the initialization voltage VI, for example.

The second frame period FR2 may include first to seventh periods TP1B, TP2B, TP3B, TP4B, TP5B, TP6B and TP7B. In the first to seventh periods TP1B, TP2B, TP3B, TP4B, TP5B, TP6B and TP7B, the second reference voltage VREF2 may maintain the initialization voltage VI. During the second frame period FR2, the eighth transistor T8 may maintain a turned off state. Accordingly, the eighth transistor T8 may not generate the driving current ID. Accordingly, the light-emitting element EE may not receive the driving current ID. During the second frame period FR2, the pixel circuit PXB[n] may stop emitting. Accordingly, an emission frequency of the display panel 100 may be reduced.

In the illustrated embodiment, the display device 1 may perform a variable frequency driving. Accordingly, a power consumption of the display device 1 may be reduced.

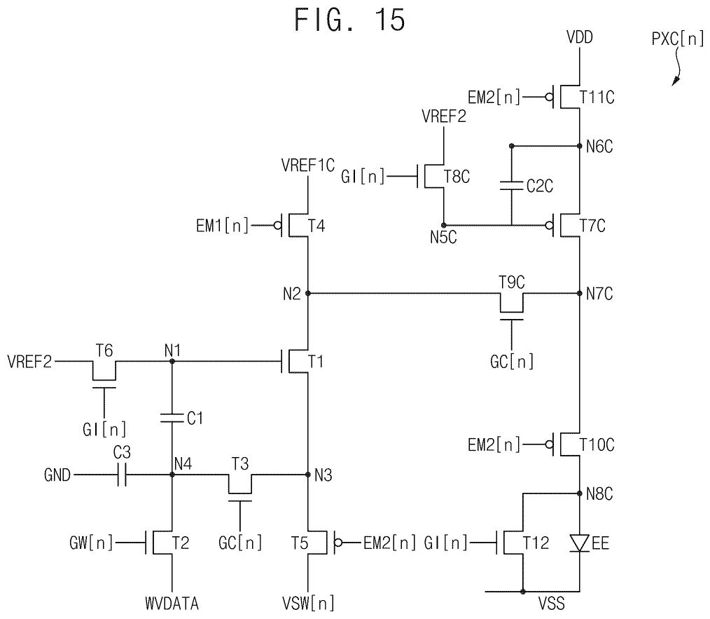

FIG. 15 is a circuit diagram illustrating an embodiment of a pixel circuit PX of FIG. 2.

Referring to FIG. 1, FIG. 2 and FIG. 15, a pixel circuit PXC[n] may include first to twelfth transistors T1, T2, T3, T4, T5, T6, T7C, T8C, T9C, T10C, T11C and T12, first to third capacitors C1, C2 and C3 and the light-emitting element EE. The first circuit block 110 may include the first to sixth transistors T1, T2, T3, T4, T5 and T6. The second circuit block 120 may include the seventh to twelfth transistors T7C, T8C, T9C, T10C, T11C and T12. The display panel 100 may include a plurality of pixel-rows. The pixel circuit PXC[n] may be included in an N-th pixel-row of the pixel-rows.

The first transistor T1 may include a control electrode connected to a first node N1, a first electrode connected to a second node N2 and a second electrode connected to a third node N3. The first transistor T1 may connect the second node N2 and the third node N3 in response to a voltage of the first node N1. In an embodiment, the first transistor T1 may be an N-type transistor.

The second transistor T2 may include a control electrode receiving a write gate signal GW[n], a first electrode receiving the pulse data voltage WVDATA and a second electrode connected to a fourth node N4. The second transistor T2 may apply the pulse data voltage WVDATA to the fourth node N4 in response to a write gate signal GW[n].

The third transistor T3 may include a control electrode receiving a compensation gate signal GC[n], a first electrode connected to the third node N3 and a second electrode connected to the fourth node N4. The third transistor T3 may connect the third node N3 and the fourth node N4 in response to the compensation gate signal GC[n].

The fourth transistor T4 may include a control electrode receiving a first emission signal EM1[n], a first electrode receiving a first reference voltage VREF1 and a second electrode connected to the second node N2. The fourth transistor T4 may apply the first reference voltage VREF1C to the second node N2 in response to the first emission signal EM1[n].

The fifth transistor T5 may include a control electrode receiving a second emission signal EM2[n], a first electrode receiving the sweep signal VSW[n] and a second electrode connected to the third node N3. The fifth transistor T5 may apply the sweep signal VSW[n] to the third node N3 in response to the second emission signal EM2[n].

The sixth transistor T6 may include a control electrode receiving an initialization gate signal GI[n], a first electrode receiving a second reference voltage VREF2 and a second electrode connected to the first node N1. The sixth transistor T6 may apply the second reference voltage VREF2 to the first node N1 in response to the initialization gate signal GI[n].

The seventh transistor T7C may include a control electrode connected to a fifth node N5C, a first electrode connected to a sixth node N6C and a second electrode connected to a seventh node N7C. The seventh transistor T7C may generate the driving current ID based on a voltage of the fifth node N5C. The seventh transistor T7C may output the driving current ID. In an embodiment, the seventh transistor T7C may be referred to as a driving transistor. In an embodiment, the seventh transistor T7C may be a P-type transistor, for example.

The eighth transistor T8C may include a control electrode receiving the initialization gate signal GI[n], a first electrode receiving the second reference voltage VREF2 and a second electrode connected to the fifth node N5C. The eighth transistor T8C may apply the second reference voltage VREF2 to the fifth node N5C in response to the initialization gate signal GI[n]. In an embodiment, the eighth transistor T8C may be referred to as a write transistor, for example.

The ninth transistor T9C may include a control electrode receiving the compensation gate signal GC[n], a first electrode connected to the second node N2 and a second electrode connected to the seventh node N7C. The tenth transistor T10 may connect the second node N2 and the seventh node N7C in response to a voltage difference between an inactivation level of the compensation gate signal GC[n] and a voltage of the second node N2. The ninth transistor T9C may output the emission control signal ECS to the seventh node N7C. In an embodiment, the ninth transistor T9C may be referred to as an output transistor, for example.

The tenth transistor T10C may include a control electrode receiving the second emission signal EM2[n], a first electrode connected to the seventh node N7C and a second electrode connected to an eighth node N8C. The tenth transistor T10C may connect the seventh node N7C and the eighth node N8C in response to the second emission signal EM2[n]. The tenth transistor T10C may output the driving current ID to the eighth node N8C in response to the second emission signal EM2[n]. In an embodiment, the tenth transistor T10C may be referred to as a first emission transistor, for example.

The eleventh transistor T11C may include a control electrode receiving the second emission signal EM2[n], a first electrode receiving the high power voltage VDD and a second electrode connected to the sixth node N6C. The eleventh transistor T11C may apply the high power voltage VDD to the sixth node N6C in response to the second emission signal EM2[n]. In an embodiment, the eleventh transistor T11C may be referred to as a second emission transistor, for example.

The twelfth transistor T12 may include a control electrode receiving the initialization gate signal GI[n], a first electrode receiving the low power voltage VSS and a second electrode connected to the eighth node N8C. The twelfth transistor T12 may apply the low power voltage VSS to the eighth node N8C in response to the initialization gate signal GI[n]. Accordingly, a black characteristic of the pixel circuit PXA[n] may be improved.

The first capacitor C1 may include a first electrode connected to the first node N1 and a second electrode connected to the fourth node N4. The second capacitor C2 may include a first electrode connected to the sixth node N6C and a second electrode connected to the fifth node N5C. The third capacitor C3 may include a first electrode connected to the fourth node N4 and a second electrode receiving a ground voltage GND. The light-emitting element EE may include a control electrode connected to the eighth node N8C and a second electrode receiving the low power voltage VSS.

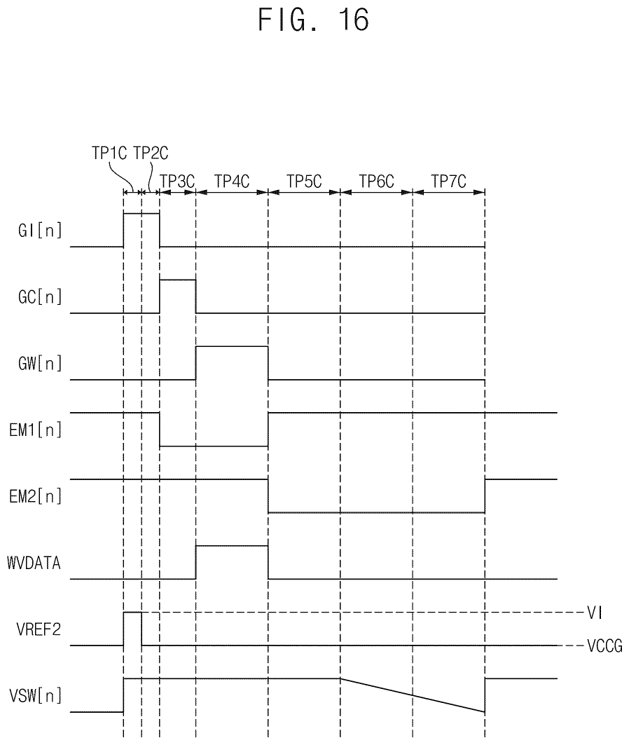

FIG. 16 is a timing diagram illustrating signals applied to a pixel circuit PXC[n] of FIG. 15.

Referring to FIG. 1, FIG. 2, FIG. 15 and FIG. 16, a frame period in which the pixel circuit PXC[n] is driven may include first to seventh periods TP1C, TP2C, TP3C, TP4C, TP5C, TP6C and TP7C.

In the illustrated embodiment, an activation level of the initialization gate signal GI[n] may be a logic high level. An inactivation level of the initialization gate signal GI[n] may be a logic low level. An activation level of the compensation gate signal GC[n] may be a logic high level. An inactivation level of the compensation gate signal GC[n] may be a logic low level. An activation level of the write gate signal GW[n] may be a logic high level. An inactivation level of the write gate signal GW[n] may be a logic low level. An activation level of the first emission signal EM1[n] may be a logic high level. An inactivation level of the first emission signal EM1[n] may be a logic low level. An activation level of the second emission signal EM2[n] may be a logic high level. An inactivation level of the second emission signal EM2[n] may be a logic low level. The sweep signal VSW[n] may be gradually decreased from a first sweep level to a second sweep level. In the illustrated embodiment, the first sweep level of the sweep signal VSW[n] may have a low voltage. In an embodiment, the first sweep level may have a voltage having a negative value, for example.

In the illustrated embodiment, the second reference voltage VREF2 may be an AC voltage. In an embodiment, the second reference voltage VREF2 may have an initialization voltage VI or a constant current voltage VCCG, for example. The initialization voltage VI may be a voltage such that the driving transistor is turned off. The constant current voltage VCCG may be a voltage for generating the driving current. In an embodiment, the constant current voltage VCCG may have a voltage level of the same magnitude for all pixels, for example. The constant current voltage VCCG may have a first voltage level for a red pixel, a second voltage level different from the first voltage level for a green pixel and a third voltage level different from the first voltage level and the second voltage level for a blue pixel. In an embodiment, the constant current voltage VCCG may be referred to as a pixel data voltage AVDATA, for example.

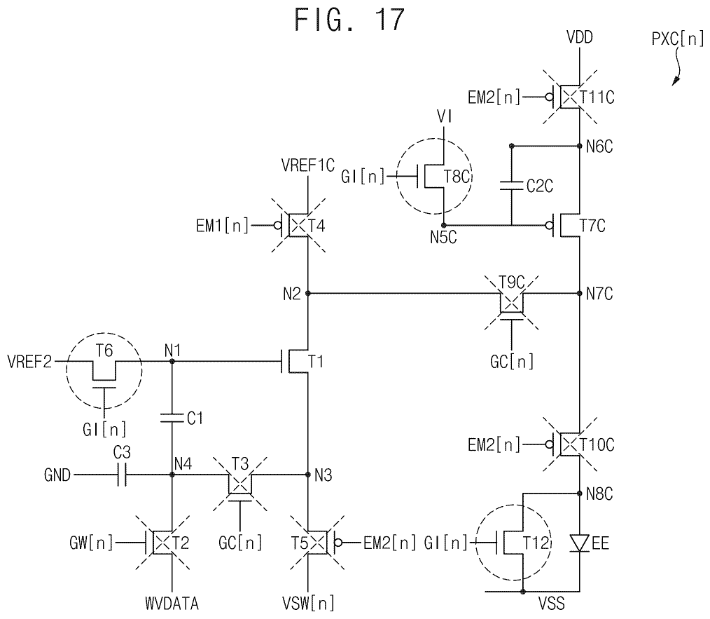

FIG. 17 is a circuit diagram illustrating an operation of a pixel circuit PXC[n] of FIG. 15 in a first period TP1C of FIG. 16.

Referring to FIG. 1, FIG. 2, FIG. 15 to FIG. 17, in the first period TP1C, the initialization gate signal GI[n] may have an activation level, the compensation gate signal GC[n] may have an inactivation level, the write gate signal GW[n] may have an inactivation level, the first emission signal EM1[n] may have an inactivation level, the second emission signal EM2[n] may have an inactivation level and the second reference voltage VREF2 may have the initialization voltage VI.

In the first period TP1C, the eighth transistor T8C may be turned on in response to the initialization gate signal GI[n]. The eighth transistor T8C may be turned on, so that the initialization voltage VI may be applied to the fifth node N5C. In the first period TP1C, the sixth transistor T6 may be turned on in response to the initialization gate signal GI[n]. The sixth transistor T6 may be turned on, so that the second reference voltage VREF2 may be applied to the first node N1. In the first period TP1C, the twelfth transistor T12 may be turned on in response to the initialization gate signal GI[n]. The twelfth transistor T12 may be turned on, so that the low power voltage VSS may be applied to the eighth node N8C. Accordingly, a black characteristic of the light-emitting element EE may be improved.

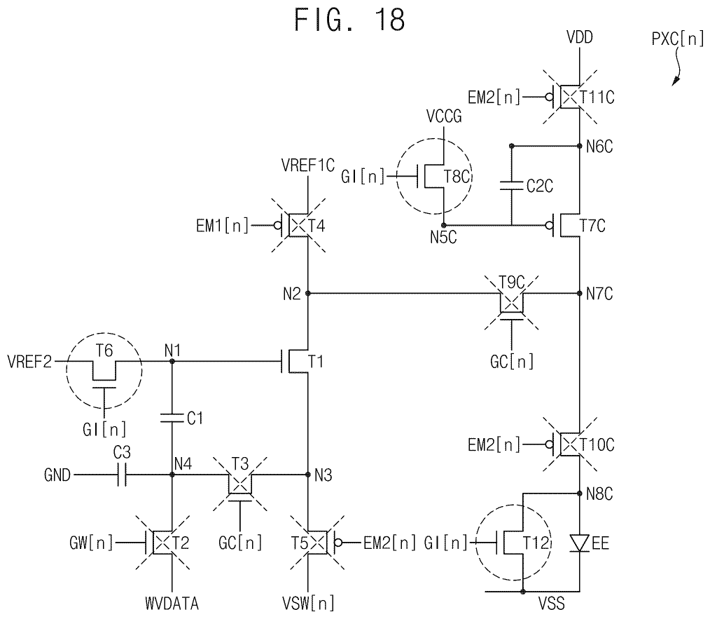

FIG. 18 is a circuit diagram illustrating an operation of a pixel circuit PXC[n] of FIG. 15 in a second period TP2C of FIG. 16.

Referring to FIG. 1, FIG. 2, FIG. 15 and FIG. 18, in the second period TP2C, the initialization gate signal GI[n] may have an activation level, the compensation gate signal GC[n] may have an inactivation level, the write gate signal GW[n] may have an inactivation level, the first emission signal EM1[n] may have an inactivation level, the second emission signal EM2[n] may have an inactivation level and the second reference voltage VREF2 may have the constant current voltage VCCG.

In the second period TP2C, the second reference voltage VREF2 may have the constant current voltage VCCG. In the second period TP2A, the constant current voltage VCCG may applied to the fifth node N5C.

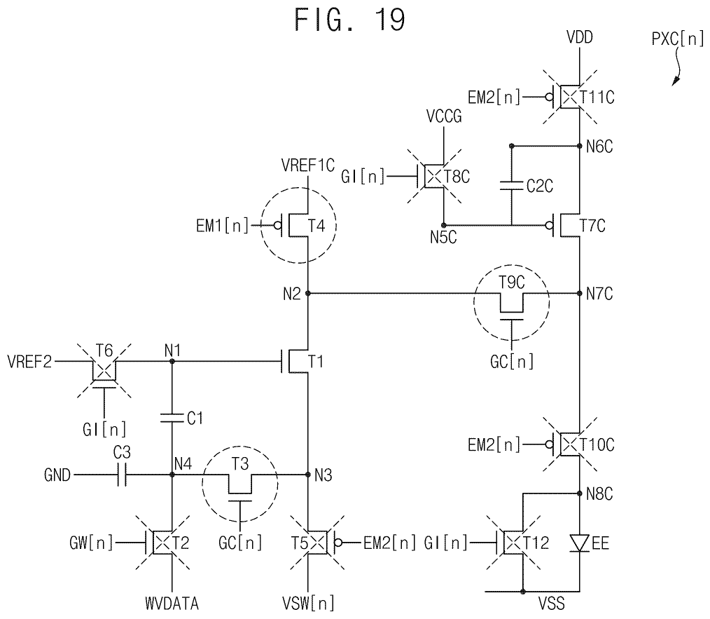

FIG. 19 is a circuit diagram illustrating an operation of a pixel circuit PXC[n] of FIG. 15 in a third period TP3C of FIG. 16.

Referring to FIG. 1, FIG. 2, FIG. 15 to FIG. 19, in the third period TP3C, the initialization gate signal GI[n] may have an inactivation level, the compensation gate signal GC[n] may have an activation level, the write gate signal GW[n] may have an inactivation level, the first emission signal EM1[n] may have an activation level, the second emission signal EM2[n] may have an inactivation level and the second reference voltage VREF2 may have the constant current voltage VCCG.

In the third period TP3C, the fourth transistor T4 may be turned on in response to the first emission signal EM1[n]. The fourth transistor T4 may be turned on, so that the first reference voltage VREF1C may be applied to the second node N2. In the illustrated embodiment, the first reference voltage VREF1C may have a reference high voltage. The reference high voltage may have a voltage having a positive value. In the third period TP3C, the third node N3 may may have the second sweep level. In the third period TP3C, the first transistor T1 may be turned on based on a voltage difference between the first node N1 and the third node N3. In the third period TP3C, the third transistor T3 may be turned on in response to the compensation gate signal GC[n]. The third transistor T3 may be turned on, so that the third node N3 and the fourth node N4 may be connected. The fourth transistor T4, the first transistor T1 and the third transistor T3 may be turned on, so that the first reference voltage VREF1C may be applied to the fourth node N4. Accordingly, the fourth node N4 may be initialized as the first reference voltage VREF1C.

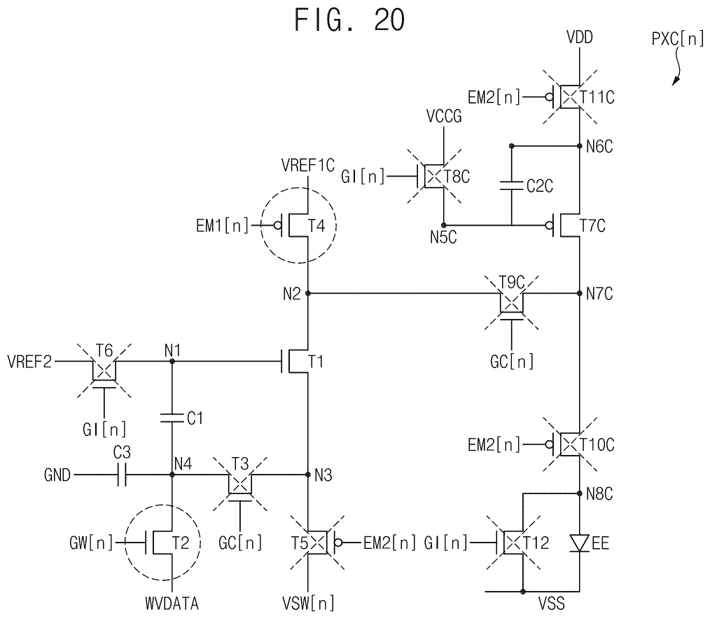

FIG. 20 is a circuit diagram illustrating an operation of a pixel circuit PXC[n] of FIG. 15 in a fourth period TP4C of FIG. 16.

Referring to FIG. 1, FIG. 2, FIG. 15 to FIG. 20, in the fourth period TP4C, the initialization gate signal GI[n] may have an inactivation level, the compensation gate signal GC[n] may have an inactivation level, the write gate signal GW[n] may have an activation level, the first emission signal EM1[n] may have an activation level, the second emission signal EM2[n] may have an inactivation level and the second reference voltage VREF2 may have the constant current voltage VCCG.

In the fourth period TP4C, the second transistor T2 may be turned on in response to the write gate signal GW[n]. The second transistor T2 may be turned on, so that the pulse data voltage WVDATA may be applied to the fourth node N4. The pulse data voltage WVDATA may be applied to the fourth node N4, so that a coupling voltage corresponding to the pulse data voltage WVDATA may be applied to the first node N1.

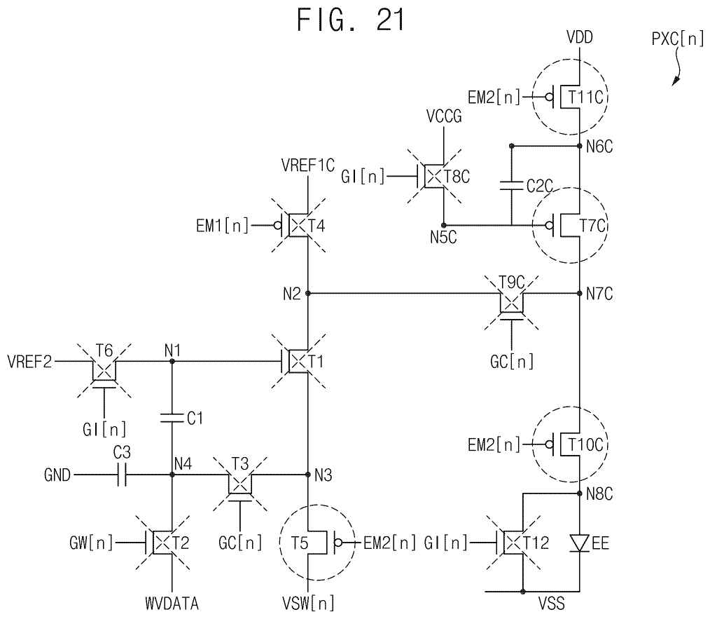

FIG. 21 is a circuit diagram illustrating an operation of a pixel circuit PXC[n] of FIG. 15 in a fifth period TP5C and a sixth period TP6C of FIG. 16.

Referring to FIG. 1, FIG. 2, FIG. 15 to FIG. 21, in the fifth period TP5C, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level and the second reference voltage VREF2 may have the constant current voltage VCCG.

In the sixth period TP6C, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level, the second reference voltage VREF2 may have the constant current voltage VCCG and the sweep signal VSW[n] may be gradually decreased from a first sweep level. In an embodiment, the sixth period TP6C may be referred to as an emission period, for example.

In the fifth period TP5C, the tenth transistor T10C and the eleventh transistor T11C may be turned on in response to the second emission signal EM2[n]. Accordingly, the driving current ID may be applied to the light-emitting element EE. The light-emitting element EE may emit light based on the driving current ID.

In the sixth period TP6C, the tenth transistor T10C and the eleventh transistor T11C may be turned on in response to the second emission signal EM2[n]. Accordingly, the driving current ID may be applied to the light-emitting element EE. The light-emitting element EE may emit light based on the driving current ID. In the sixth period TP6C, the fifth transistor T5 may be turned on in response to the second emission signal EM2[n]. The fifth transistor T5 may be turned on, so that the sweep signal VSW[n] may be applied to the third node N3. The sweep signal VSW[n] may be applied to the third node N3, so that a voltage of the third node N3 may be gradually decreased. In the sixth period TP6C, an absolute value of a voltage difference between an activation level the second emission signal EM2[n] and a voltage of the second node N2 may be lower than an absolute value of a threshold voltage of the ninth transistor T9C. Accordingly, in the sixth period TP6C, the ninth transistor T9C may be turned off.

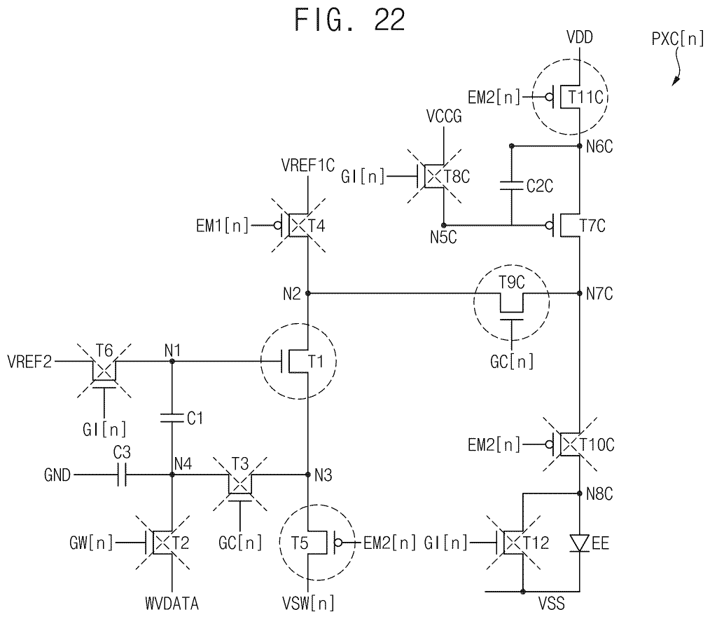

FIG. 22 is a circuit diagram illustrating an operation of a pixel circuit PXC[n] of FIG. 15 in a seventh period TP7C of FIG. 16.

Referring to FIG. 1, FIG. 2, and FIG. 15 to FIG. 22, in the seventh period TP7C, the initialization gate signal GI[n] may have an inactivation level, the compensation gate signal GC[n] may have an inactivation level, the write gate signal GW[n] may have an inactivation level, the first emission signal EM1[n] may have an inactivation level, the second emission signal EM2[n] may have an activation level, the second reference voltage VREF2 may have the constant current voltage VCCG and the sweep signal VSW[n] may be gradually decreased from a first sweep level to the second sweep level. In an embodiment, the seventh period TP7A may be referred to as an emission-off period, for example.

In the seventh period TP7C, a voltage of the third node N3 may be gradually decreased, so that the voltage difference between a voltage of the first node N1 and a voltage of the third node N3 may be higher than a threshold voltage of the first transistor T1. Accordingly, the first transistor T1 may be turned on. Accordingly, the sweep signal VSW[n] may be applied to the second node N2. The sweep signal VSW[n] may be applied to the second node N2, so that the second node N2 may have a voltage lower than the first reference voltage VREF1C. Accordingly, an absolute value of a voltage difference between an inactivation level of the compensation gate signal GC[n] and a voltage of the second node N2 may be higher than an absolute value of a threshold voltage of the ninth transistor T9C. Accordingly, the ninth transistor T9C may be turned on. The ninth transistor T9C may be turned on, so that the emission control signal ECS may be applied to the seventh node N7C. Accordingly, a voltage of the seventh node N7C may be decreased. The voltage of the seventh node N7C may be decreased, so that the tenth transistor T10C may be turned off. In an embodiment, an absolute value of a voltage difference between the voltage of the seventh node N7C and an inactivation level of the second emission signal EM2[n] may be lower than an absolute value of a threshold voltage of the tenth transistor T10C, for example. Accordingly, the tenth transistor T10C may be turned off. The tenth transistor T10C may be turned off, so that the light-emitting element EE may not receive the driving current ID. Accordingly, the light-emitting element EE may stop emitting.

In the illustrated embodiment, the emission control signal ECS may be generated based on the sweep signal VSW[n] and the pulse data voltage WVDATA, and generation of the driving current ID may be controlled based on the emission control signal ECS. Accordingly, an emitting time in which the light-emitting element EE emits light may be controlled based on the pulse data voltage WVDATA. Accordingly, a grayscale of the display panel 100 may be controlled. The control method may be a pulse width modulation.

Additionally, in the illustrated embodiment, the display device 1 may perform internal compensation of threshold voltage, and include a relatively small number of transistors. Accordingly, an integration of the pixel circuit PXC[n] may be improved.

Additionally, in the illustrated embodiment, the first transistor T1 may be an N-type transistor. Accordingly, a hysteresis characteristic of the first circuit block 110 may be improved. Accordingly, a reliability of the emission control signal ECS may be improved. The reliability of the emission control signal ECS may be improved, so that a display quality of the display panel 100 may be improved.

Additionally, in the illustrated embodiment, the first circuit block 110 may perform an internal compensating method which is source-follower method. Accordingly, when the first transistor T1 included in the first circuit block 110 is an N-type transistor, a reliability of a compensation may be improved.

Additionally, in the illustrated embodiment, the seventh transistor T7C may be a P-type transistor. Accordingly, a reliability of the driving current ID may be improved. The reliability of the driving current ID may be improved, so that an emission efficiency of the light-emitting element EE may be improved. Additionally, a display quality of the display panel 100 may be improved.

Referring to FIG. 1, FIG. 2, FIG. 12 and FIG. 15, in the illustrated embodiment, the display panel 100 may be driven as a variable frequencies. In an embodiment, when the driving frequency in which the display panel 100 is driven is decreased, in a second frame period FR2 following to a first frame period FR1, the second reference voltage VREF2 may maintain the initialization voltage VI, for example.

During the second frame period FR2, the second reference voltage VREF2 may maintain the initialization voltage VI. During the second frame period FR2, the seventh transistor T7C may maintain a turned off state. Accordingly, the seventh transistor T7C may not generate the driving current ID. Accordingly, the light-emitting element EE may not receive the driving current ID. During the second frame period FR2, the pixel circuit PXC[n] may stop emitting. Accordingly, an emission frequency of the display panel 100 may be reduced.

In the illustrated embodiment, the display device 1 may perform a variable frequency driving. Accordingly, a power consumption of the display device 1 may be reduced.

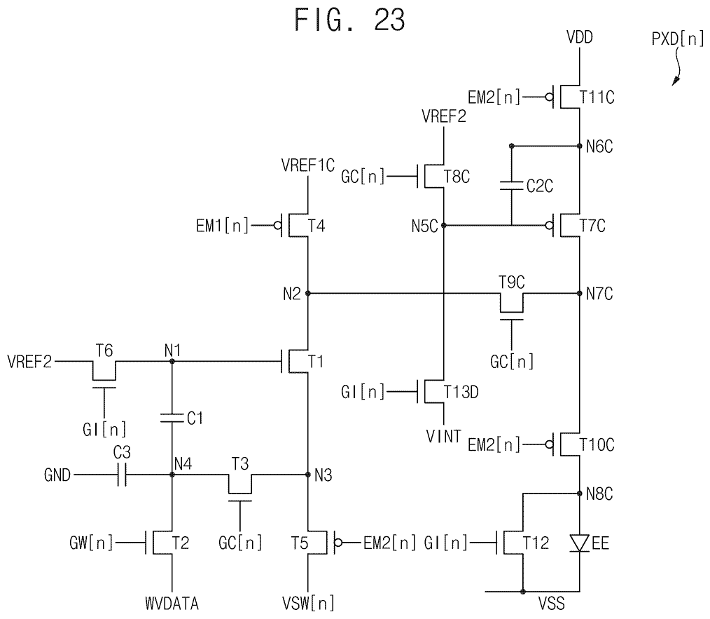

FIG. 23 is a circuit diagram illustrating an embodiment of a pixel circuit PX of FIG. 2.

Referring to FIG. 23, a pixel circuit PXD[n] may include first transistor to thirteenth transistors T1, T2, T3, T4, T5, T6, T7C, T8C, T9C, T10C, T11C, T12 and T13D, the first to third capacitors C1, C2 and C3 and the light-emitting element EE. The display panel 100 may include a plurality of pixel-rows. The pixel circuit PXD[n] may be included in an N-th pixel-row of the pixel-rows.

The pixel circuit PXD[n] of FIG. 23 is substantially same as the pixel circuit PXC[n] of FIG. 15 except that the pixel circuit PXD[n] further includes the thirteenth transistor T13D, and the ninth transistor T9B receives the compensation gate signal GC[n], so that the same reference numerals will be used and any repetitive explanation concerning the above elements will be omitted.

In the illustrated embodiment, the eighth transistor T8C may be turned on in response to the compensation gate signal GC[n]. The thirteenth transistor T13D may include a control electrode receiving the initialization gate signal GI[n], a first electrode receiving an initialization voltage VINT and a second electrode connected to the fifth node N5C. The thirteenth transistor T13D may apply the initialization voltage VINT to the fifth node N5 in response to the initialization gate signal GI[n].

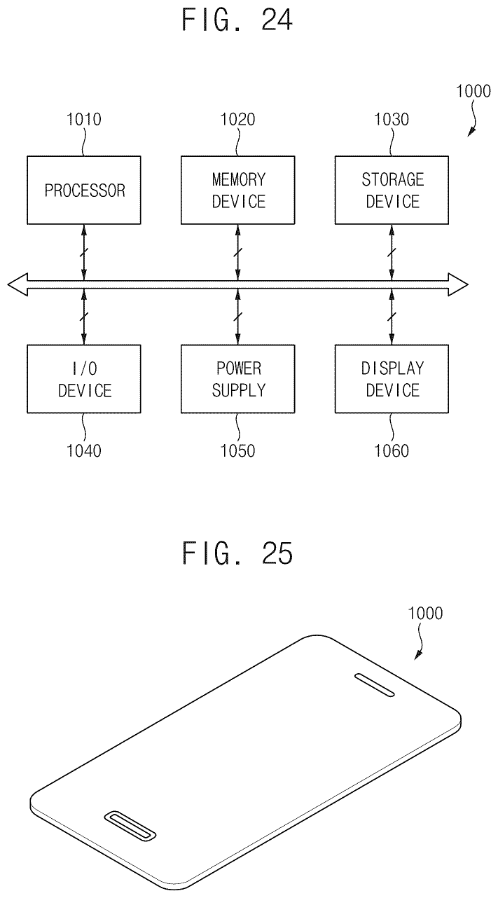

FIG. 24 is a block diagram illustrating an embodiment of an electronic device 1000 according to the inventive concept. FIG. 25 is a diagram illustrating an embodiment in which the electronic device of FIG. 24 is implemented as a smart phone.

Referring to FIG. 24, the electronic device 1000 may include a processor 1010, a memory device 1020, a storage device 1030, an input/output (“I/O”) device 1040, a power supply 1050, and a display device 1060. Here, the display device 1060 may be the display apparatus of FIG. 1. Additionally, the electronic device 1000 may further include a plurality of ports for communicating with a video card, a sound card, a memory card, a universal serial bus (“USB”) device, other electronic device, etc.

In an embodiment, as illustrated in FIG. 25, the electronic device 1000 may be implemented as a smart phone. However, the electronic device 1000 is not limited thereto. In an embodiment, the electronic device 1000 may be implemented as a cellular phone, a video phone, a smart pad, a smart watch, a tablet personal computer (“PC”), a car navigation system, a computer monitor, a laptop, a head mounted display (“HMD”) device, or the like, for example.

The processor 1010 may perform various computing functions or various tasks. The processor 1010 may be a micro-processor, a central processing unit (“CPU”), an application processor (“AP”), or the like. The processor 1010 may be coupled to other components via an address bus, a control bus, a data bus, etc. Further, the processor 1010 may be coupled to an extended bus such as a peripheral component interconnection (“PCI”) bus.

The processor 1010 may output the input image data IMG and the input control signal CONT to the driving controller 200 of FIG. 1. In an embodiment, the processor 1010 may further output an app-on signal to the driving controller 200.

The memory device 1020 may store data for operations of the electronic device 1000. In an embodiment, the memory device 1020 may include at least one non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, or the like and/or at least one volatile memory device such as a dynamic random access memory (“DRAM”) device, a static random access memory (“SRAM”) device, a mobile DRAM device, or the like, for example.

The storage device 1030 may include a solid state drive (“SSD”) device, a hard disk drive (“HDD”) device, a compact disc read-only memory (“CD-ROM”) device, or the like. The I/O device 1040 may include an input device such as a keyboard, a keypad, a mouse device, a touch-pad, a touch-screen, or the like and an output device such as a printer, a speaker, or the like. In some embodiments, the display device 1060 may be included in the I/O device 1040. The power supply 1050 may provide power for operations of the electronic device 1000. The display device 1060 may be coupled to other components via the buses or other communication links.

Referring to FIG. 25, the electronic apparatus of the inventive concept is shown implemented as a smartphone, but the inventive concept is not limited thereto. The electronic apparatus may be a television, a monitor, a laptop computer, or a tablet. Additionally, the electronic apparatus may be a car.

The display apparatus in the embodiments may be applied to a display apparatus included in a computer, a notebook, a mobile phone, a smart phone, a smart pad, a portable media player (“PMP”), a personal digital assistance (“PDA”), a motion pictures expert group audio layer III (“MP3”) player, or the like.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the illustrative embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A pixel circuit comprising:
a first circuit block configured to output an emission control signal based on a sweep signal and a pulse data voltage, the first circuit block including:
a first transistor including:
a control electrode connected to a first node;
a first electrode connected to a second node; and
a second electrode connected to a third node;
a second transistor configured to apply the pulse data voltage to a fourth node in response to a write gate signal;
a third transistor configured to connect the third node and the fourth node in response to a compensation gate signal;
a fourth transistor configured to apply a first reference voltage to the second node in response to a first emission signal;
a fifth transistor configured to apply the sweep signal to the third node in response to a second emission signal; and
a first capacitor including:
a first electrode connected to the first node; and
a second electrode connected to the fourth node;
a second circuit block configured to output a driving current based on a pixel data voltage and the emission control signal; and
a light-emitting element configured to emit light based on the driving current,
wherein the second node outputs the emission control signal.

2. The pixel circuit of claim 1, wherein the second circuit block includes:
an output transistor configured to output the emission control signal to a fifth node;
a driving transistor configured to generate the driving current in response to a voltage of the fifth node; and
a write transistor configured to apply a second reference voltage to the fifth node in response to an initialization gate signal.

3. The pixel circuit of claim 2, wherein the first transistor is an N-type transistor, and the driving transistor is a P-type transistor.

4. The pixel circuit of claim 2, wherein the driving transistor includes a control electrode connected to the fifth node, a first electrode which receives a high power voltage having a relatively high power voltage level and a second electrode connected to a sixth node, and
wherein the second circuit block further includes a compensation transistor configured to connect the fifth node and the sixth node in response to the compensation gate signal.

5. The pixel circuit of claim 4, wherein a frame period in which the pixel circuit is driven includes first to seventh periods,
wherein in the first period, the initialization gate signal has an activation level, and the second reference voltage has an initialization voltage, and
wherein in the first period, the write transistor is turned on in response to the initialization gate signal.

6. The pixel circuit of claim 5, wherein in the second period, the initialization gate signal has an activation level, and the second reference voltage has the pixel data voltage, and
wherein in the first period, the pixel data voltage is applied to the fifth node.

7. The pixel circuit of claim 6, wherein in the third period, the compensation gate signal has an activation level, and the first emission signal has an activation level, and
wherein in the third period, the compensation transistor is turned on, the third transistor is turned on, and the fourth transistor is turned on.

8. The pixel circuit of claim 7, wherein in the fourth period, the write gate signal has an activation level, and
wherein in the fourth period, the second transistor is turned on.

9. The pixel circuit of claim 8, wherein in the fifth period, the first emission signal has an inactivation level, and the second emission signal has an activation level.

10. The pixel circuit of claim 9, wherein in the sixth period, the first emission signal has the inactivation level, the second emission signal has an activation level, and the sweep signal is gradually decreased from a first sweep level to a second sweep level.

11. The pixel circuit of claim 10, wherein in the seventh period, the output transistor is turned on, the emission control signal is applied to the fifth node, and the driving transistor is turned off.

12. The pixel circuit of claim 2, wherein a frame period in which the pixel circuit is driven includes a first frame period and a second frame period, and
wherein the driving transistor is turned on in the first frame period, and the driving transistor is turned off in the second frame period.

13. The pixel circuit of claim 12, wherein in the first frame period, the second reference voltage has the pixel data voltage or an initialization voltage, and
wherein in the second frame period, the second reference voltage maintains the initialization voltage.

14. The pixel circuit of claim 1, wherein the second circuit block includes:
an output transistor configured to output the emission control signal to a fifth node;
a driving transistor configured to generate the driving current in response to a voltage of the fifth node;
a write transistor configured to apply a second reference voltage to the fifth node in response to the compensation gate signal; and
an initialization transistor configured to apply an initialization voltage to the fifth node in response to an initialization gate signal.

15. The pixel circuit of claim 1, wherein the second circuit block includes:
a driving transistor including a control electrode connected to a fifth node, a first electrode connected to a sixth node and a second electrode connected to a seventh node;
an output transistor configured to output the emission control signal to the seventh node;
a write transistor configured to apply a second reference voltage to the fifth node in response to an initialization gate signal; and
a compensation capacitor including a first electrode connected to the sixth node and a second electrode connected to the fifth node.

16. The pixel circuit of claim 15, wherein the first transistor is an N-type transistor, and the driving transistor is a P-type transistor.

17. The pixel circuit of claim 15, wherein the second circuit block further includes an initialization transistor configured to apply an initialization voltage to the fifth node in response to the initialization gate signal.

18. The pixel circuit of claim 1, further comprising a light-emitting element initialization transistor,
wherein the light-emitting element includes a first electrode which receives the driving current and a second electrode which receives a low power voltage having a relatively low power voltage level, and
wherein the light-emitting element initialization transistor applies the low power voltage to the first electrode of the light-emitting element in response to an initialization gate signal.

19. An electronic device comprising:
a display panel including a pixel circuit, the pixel circuit including:
a first circuit block configured to output an emission control signal based on a sweep signal and a pulse data voltage, the first circuit block including:
a first transistor including a control electrode connected to a first node, a first electrode connected to a second node and a second electrode connected to a third node;
a second transistor configured to apply the pulse data voltage to a fourth node in response to a write gate signal;
a third transistor configured to connect the third node and the fourth node in response to a compensation gate signal;
a fourth transistor configured to apply a first reference voltage to the second node in response to a first emission signal;
a fifth transistor configured to apply the sweep signal to the third node in response to a second emission signal; and
a first capacitor including a first electrode connected to the first node and a second electrode connected to the fourth node;
a second circuit block configured to output a driving current based on a pixel data voltage and the emission control signal; and
a light-emitting element configured to emit light based on the driving current;
a gate driver configured to output gate signals including the write gate signal and the compensation gate signal to the pixel circuit;
a sweep signal outputter configured to output the sweep signal to the pixel circuit;
a data driver configured to apply the pulse data voltage and the pixel data voltage to the pixel circuit;
a driving controller configured to control the gate driver, the sweep signal outputter and the data driver based on an input control signal; and
a processor configured to output the input control signal
wherein the second node outputs the emission control signal.

20. The electronic device of claim 19, wherein the second circuit block includes:
an output transistor configured to output the emission control signal to a fifth node;
a driving transistor configured to generate the driving current in response to a voltage of the fifth node; and
a write transistor configured to apply a second reference voltage to the fifth node in response to an initialization gate signal of the gate signals, and
wherein the first transistor is an N-type transistor, and the driving transistor is a P-type transistor.
